(19) United States
(12) Patent Application Publication
(10) Pub. No.: US 2021/0089818 A1
(43) Pub. Date: Mar. 25, 2021

(54) DEPOSIT DETECTION DEVICE AND DEPOSIT DETECTION METHOD

(71) Applicant: DENSO TEN Limited, Kobe-shi (JP)

(72) Inventors: Nobunori ASAYAMA, Kobe-shi (JP); Nobuhisa IKEDA, Kobe-shi (JP); Takashi KONO, Kobe-shi (JP); Yasushi TANI, Kobe-shi (JP); Daisuke YAMAMOTO, Kobe-shi (JP); Tomokazu OKI, Kobe-shi (JP); Teruhiko KAMIBAYASHI, Kobe-shi (JP)

(73) Assignee: DENSO TEN Limited, Kobe-shi (JP)

(21) Appl. No.: 17/018,017

(22) Filed: Sep. 11, 2020

(30) Foreign Application Priority Data
Sep. 20, 2019 (JP) 2019-172213

(51) Int. Cl. G06K 9/62; G06T 7/11; G06T 7/136

(52) U.S. Cl. CPC G06K 9/6217; G06T 7/136; G06T 7/11

(57) ABSTRACT

A deposit detection device according to an embodiment includes a detection module, an extraction module, and an identification module. The detection module detects a candidate region for a deposit region corresponding to a deposit adhering to an imaging device, based on brightness information for each of small regions into which a predetermined region in an image captured by the imaging device is divided. The extraction module extracts, as a boundary region, the small region in which a brightness difference value from the small region adjacent to the small region is equal to or larger than a predetermined threshold value, from among the small regions included in the candidate region detected by the detection module. The identification module identifies the candidate region as the deposit region when the number of boundary regions extracted by the extraction module satisfies a predetermined identification condition.

### CROSS-REFERENCE TO RELATED APPLICATION

This application is based upon and claims the benefit of priority of the prior Japanese Patent Application No. 2019-172213, filed on Sep. 20, 2019, the entire contents of which are incorporated herein by reference.

### FIELD

The embodiments discussed herein are directed to a deposit detection device and a deposit detection method.

### BACKGROUND

Conventionally, a deposit detection device is known which detects a region (hereinafter referred to as a deposit region) corresponding to a deposit adhering to a lens of an imaging device by calculating brightness information for each of small regions into which a predetermined region of a captured image is divided, and extracting a small region having the calculated brightness information in a predetermined range (for example, refer to Japanese Laid-open Patent Publication No. 2018-191087).

Unfortunately, the conventional technique has room for improvement in detecting a deposit with high accuracy. For example, in a case of an image captured in a twilight state, the entire image is dark and is less likely to exhibit a feature of brightness information for detecting a deposit region, possibly leading to reduction in accuracy in detecting a deposit region.

### SUMMARY

A deposit detection device according to an embodiment includes a detection module, an extraction module, and an identification module. The detection module detects a candidate region for a deposit region corresponding to a deposit adhering to an imaging device, based on brightness information for each of small regions into which a predetermined region in an image captured by the imaging device is divided. The extraction module extracts, as a boundary region, the small region in which a brightness difference value from the small region adjacent to the small region is equal to or larger than a predetermined threshold value, from among the small regions included in the candidate region detected by the detection module. The identification module identifies the candidate region as the deposit region when the number of boundary regions extracted by the extraction module satisfies a predetermined identification condition.

### BRIEF DESCRIPTION OF DRAWINGS

FIG. 1 is a diagram illustrating an overview of a deposit detection method according to an embodiment;

FIG. 2 is a block diagram illustrating a configuration of a deposit detection device according to the embodiment;

FIG. 3 is a diagram illustrating a process in a control unit including an identification module;

FIG. 4 is a diagram illustrating a process of resetting a candidate count number performed by a detection module; and

FIG. 5 is a flowchart illustrating a procedure of a process performed by the deposit detection device according to the embodiment.

### DESCRIPTION OF EMBODIMENTS

Embodiments of a deposit detection device and a deposit detection method disclosed by the subject application will be described in detail below with reference to the accompanying drawings. It should be noted that the present invention is not limited by the embodiments illustrated below.

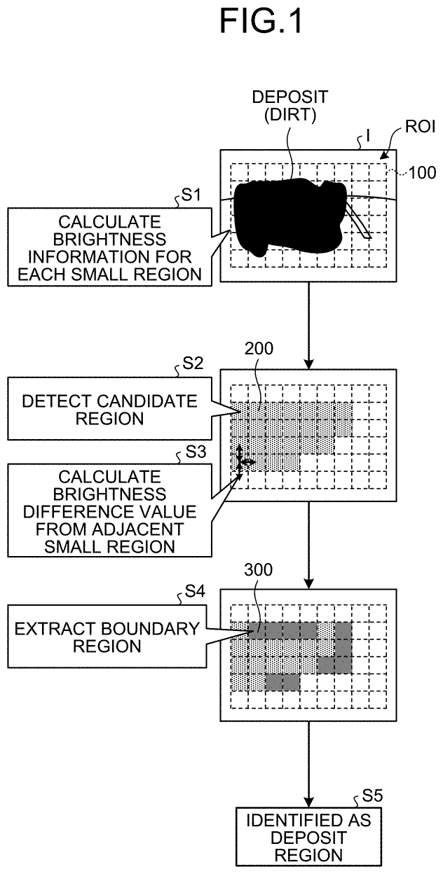

First, referring to FIG. 1, an overview of the deposit detection method according to an embodiment will be described. FIG. 1 is a diagram illustrating an overview of the deposit detection method according to the embodiment. The upper section of FIG. 1 illustrates an image I (hereinafter, captured image I) captured, for example, in a state in which a light-blocking deposit such as dirt adheres to a lens of a camera (an example of imaging device) mounted on a vehicle. When such a light-blocking deposit adheres, a deposit region in the captured image I is in a blocked-up shadow state. The light-blocking deposit includes dirt as well as insects and dust.

A conventional deposit detection method will now be described. Conventionally, a deposit region corresponding to a deposit adhering to a lens of an imaging device is detected by calculating brightness information for each of small regions (small regions 100 illustrated in FIG. 1) into which a predetermined region (a predetermined region ROI illustrated in FIG. 1) in a captured image is divided, and extracting a small region having the calculated brightness information in a predetermined range.

Unfortunately, the conventional deposit detection method has room for improvement in detecting a deposit with high accuracy. For example, in a case of an image captured in a twilight state, the entire captured image is slightly dark (the brightness of the entire image is slightly higher than that at night) and is less likely to exhibit a feature of brightness information for detecting a deposit region, possibly leading to reduction in accuracy in detecting a deposit region. For example, brightness information of a region originally with low brightness, such as roads and shadow regions, may be affected by twilight and become similar to brightness information of a deposit region, and therefore the region originally with low brightness may be erroneously detected as a deposit region.

Then, in the deposit detection method according to the embodiment, a deposit region is detected by comparison of brightness between adjacent small regions 100 in addition to the brightness information for each small region 100.

Specifically, first, in the deposit detection method according to the embodiment, brightness information for each of small regions 100 into which a predetermined region ROI in the captured image I is divided is calculated (step S1). Subsequently, in the deposit detection method according to the embodiment, a candidate region 200 for a deposit region corresponding to a deposit adhering to the camera is detected based on the calculated brightness information (step S2). The candidate region 200 refers to a region that includes at least a predetermined number or more of small regions 100 having the brightness information satisfying a predetermined condition.

Subsequently, in the deposit detection method according to the embodiment, a brightness difference value from an adjacent small region 100 is calculated for each of the small regions 100 included in the candidate region 200 (step S3). Specifically, in the deposit detection method according to the embodiment, brightness difference values from small regions 100 adjacent on the upper, lower, left, and right sides are calculated with reference to a small region 100 included in the candidate region 200. The brightness difference value is, for example, a difference value of the brightness averages of pixels included in the small regions 100.

Subsequently, in the deposit detection method according to the embodiment, the small region 100 in which the brightness difference value from the adjacent small region 100 is equal to or larger than a predetermined threshold value is extracted as a boundary region 300 from among the small regions 100 included in the candidate region 200 (step S4).

Subsequently, in the deposit detection method according to the embodiment, if the number of extracted boundary regions 300 satisfies a predetermined identification condition, the candidate region 200 is identified as a deposit region (step S5).

That is, in the deposit detection method according to the embodiment, a deposit region is identified using such characteristic of a light-blocking deposit such as dirt that the deposit region is in a blocked-up shadow state. Specifically, since there is a difference in brightness information between a deposit region and a region other than the deposit region even in the twilight, this difference in brightness information produces a boundary between the deposit region and the region other than the deposit region.

That is, in the deposit detection method according to the embodiment, the boundary region 300 that is the boundary between a deposit region and a region other than the deposit region is detected, whereby the deposit region can be isolated from the other region with high accuracy even in a situation in which the entire image is slightly dark as in the twilight.

The deposit detection method according to the embodiment therefore can detect a deposit with high accuracy.

In the deposit detection method according to the embodiment, when a state in which the boundary region 300 satisfies the identification condition continues for a predetermined period, the region is finally identified as a deposit region, which will be describe later.

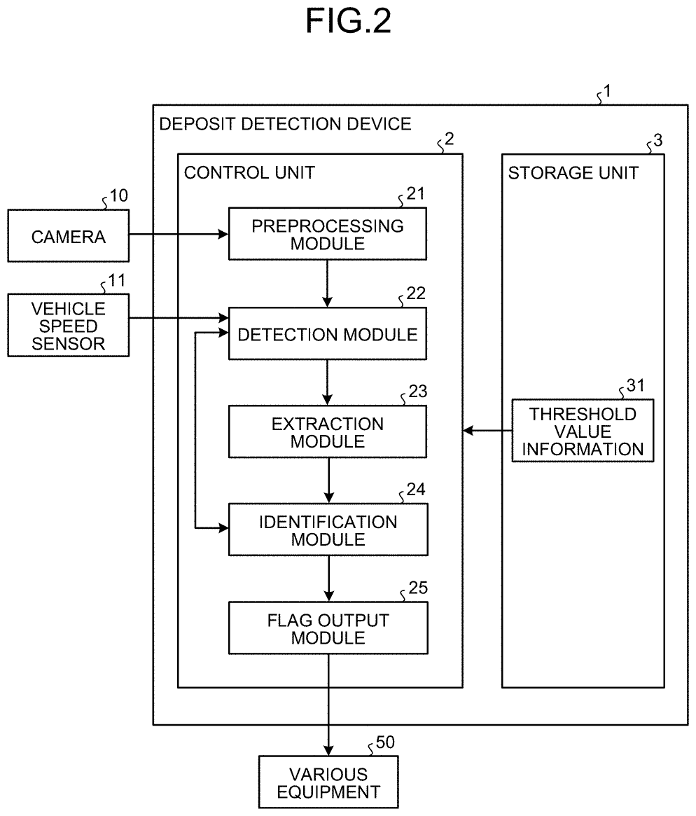

Referring now to FIG. 2, a configuration of the deposit detection device 1 according to an embodiment will be described. FIG. 2 is a block diagram illustrating the configuration of the deposit detection device 1 according to an embodiment. As illustrated in FIG. 2, the deposit detection device 1 according to an embodiment is connected with a camera 10, a vehicle speed sensor 11, and various equipment 50. Although the deposit detection device 1 illustrated in FIG. 2 is a separate component from the camera 10 and the various equipment 50, the deposit detection device 1 may be integrated with at least one of the camera 10 and the various equipment 50.

The camera 10 is, for example, an on-vehicle camera including a lens such as a fish-eye lens and an imager such as a charge-coupled device (CCD) or a complementary metal oxide semiconductor (CMOS). The cameras 10 are provided, for example, at positions where images at the front, back, left side, and right side of the vehicle can be captured, and output the captured images I to the deposit detection device 1.

The vehicle speed sensor 11 is a sensor that detects the speed of the vehicle. The vehicle speed sensor 11 outputs information on the detected vehicle speed to the deposit detection device 1.

The various equipment 50 acquires the detection result from the deposit detection device 1 to perform a variety of control on the vehicle. The various equipment 50 includes, for example, a display device indicating that a deposit adheres to the lens of the camera 10 and notifies the user of an instruction to wipe off the deposit, a removal device that ejects fluid, gas, or the like toward the lens to remove the deposit, and a vehicle control device for controlling autonomous driving, for example.

As illustrated in FIG. 2, the deposit detection device 1 according to an embodiment includes a control unit 2 and a storage unit 3. The control unit 2 includes a preprocessing module 21, a detection module 22, an extraction module 23, an identification module 24, and a flag output module 25. The storage unit 3 stores therein threshold value information 31.

Here, the deposit detection device 1 includes, for example, a computer having a central processing unit (CPU), a read-only memory (ROM), a random-access memory (RAM), a data flash, and an input-output port, and a variety of circuits.

The CPU of the computer reads and executes a computer program stored in the ROM, for example, to function as the preprocessing module 21, the detection module 22, the extraction module 23, the identification module 24, and a flag output module 25 of the control unit 2.

At least one or all of the preprocessing module 21, the detection module 22, the extraction module 23, the identification module 24, and the flag output module 25 of the control unit 2 may be configured by hardware such as an application specific integrated circuit (ASIC) and a field-programmable gate array (FPGA).

The storage unit 3 corresponds to, for example, the RAM and the data flash. The RAM and the data flash can store therein the threshold value information 31 and information of a variety of computer programs. The deposit detection device 1 may acquire the computer program and/or a variety of information described above through another computer connected via a wired or wireless network or a portable recording medium.

The threshold value information 31 stored in the storage unit 3 is information including information such as threshold values used in processes in the control unit 2. The information such as threshold values included in the threshold value information 31 is set based on the results verified in advance by experiments or the like.

The preprocessing module 21 performs predetermined preprocessing on the captured image I captured by the camera 10.

Specifically, the preprocessing module 21 performs a pixel thinning process on the acquired captured image I and generates an image having a size smaller than the acquired image. The preprocessing module 21 also generates an integrated image of the sum and the sum of squares of pixel values in the pixels, based on the image subjected to the thinning process. As used herein, the pixel value is information corresponding to brightness or an edge of a pixel.

In this way, the deposit detection device 1 can accelerate calculation in the processes in the subsequent stages by performing the thinning process on the acquired image and generating the integrated image and can reduce the process time for detecting a deposit.

The preprocessing module 21 may perform a smoothing process for each pixel, using a smoothing filter such as an averaging filter. The preprocessing module 21 does not necessarily perform the thinning process and may generate an integrated image of the captured image I having the same size as that of the acquired image.

The preprocessing module 21 outputs the captured image I that is an integrated image to the detection module 22.

The detection module 22 detects a candidate region 200 for a deposit region based on brightness information for each of small regions 100 into which a predetermined region ROI in the captured image I is divided.

Specifically, the detection module 22 first sets a predetermined region ROI and small regions 100 in the captured image I. The predetermined region ROI is a rectangular region preset according to the characteristics of the camera 10 and is a region, for example, excluding a vehicle body region and a housing region of the camera 10. The small regions 100 are rectangular regions formed by dividing the predetermined region ROI in the horizontal direction and the vertical direction. For example, each small region 100 is a region including 40×40 pixels, but the number of pixels included in the small region 100 can be set as desired.

Subsequently, the detection module 22 calculates brightness information indicating a feature amount of brightness for each small region 100. Specifically, the detection module 22 calculates an average value of brightness and a standard deviation of brightness as a feature amount, for each small region 100. The detection module 22 also calculates a feature amount of brightness (an average value of brightness and a standard deviation of brightness) in the entire predetermined region ROI.

Subsequently, the detection module 22 calculates a variation in feature amount of brightness in the captured images I from the past to the present. Specifically, the detection module 22 calculates, as a variation, a first difference that is a difference in average value of brightness in the small region 100 at the same position in the past and at present in the captured images I. That is, the detection module 22 calculates, as a variation, the first difference between the average value of brightness in the past and the average value of brightness at present for the corresponding small region 100.

The detection module 22 also calculates a second difference that is a difference in standard deviation of brightness in the small region 100 at the same position in the past and at present of the captured images I. That is, the detection module 22 calculates, as a variation, the second difference between the standard deviation of brightness in the past and the standard deviation of brightness at present for the corresponding small region 100.

Subsequently, the detection module 22 determines whether the brightness information satisfies a predetermined candidate condition, for each individual small region 100. Specifically, the detection module 22 determines that the candidate condition is satisfied when the variation in feature amount of brightness of the small region 100 in the captured images I in the past and at present falls within a predetermined threshold value range.

Subsequently, when the number of small regions 100 in which a candidate count number indicating the number of times the brightness information satisfies the candidate condition reaches a predetermined number or larger, is equal to or larger than a predetermined number, the detection module 22 detects the predetermined number of small regions 100 as a candidate region 200. That is, the detection module 22 detects, as a candidate region 200, a set of a predetermined number of small regions 100 in which the state of brightness information satisfying the candidate condition continues a predetermined number of times or more in the captured images I of a few frames from the past to the present.

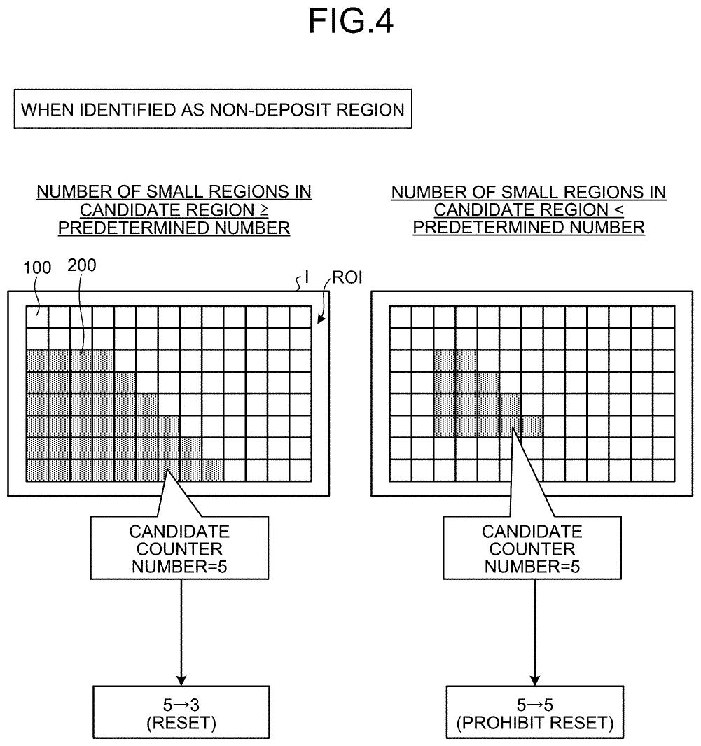

The detection module 22 resets the candidate count number described above to a predetermined value when the identification module 24 described later determines that the candidate region 200 is not a deposit region (non-deposit region), which will be described later with reference to FIG. 4.

The detection module 22 outputs information on the detected candidate region 200 to the extraction module 23.

The extraction module 23 extracts, as a boundary region 300, the small region 100 in which the brightness difference value from a small region 100 adjacent to the small region 100 is equal to or larger than a predetermined threshold value, from among the small regions 100 included in the candidate region 200 detected by the detection module 22.

Specifically, the extraction module 23 calculates the brightness difference values from small regions 100 adjacent on the upper and lower sides (the vertical direction) and small regions 100 adjacent on the left and right sides (the horizontal direction) with reference to a small region 100 included in the candidate region 200.

The brightness difference value is, for example, a difference in average value of brightness of pixels included in the small region 100. The brightness difference value may be a difference in brightness of pixels randomly selected in the small region 100 or may be a median value in a histogram in which brightness of pixels included in the small region 100 is a class. The brightness difference value may be a ratio between the brightness averages of adjacent small regions 100. The brightness difference value may be calculated by a variety of methods as long as the difference in brightness between adjacent small regions 100 can be quantified.

The extraction module 23 then extracts, as a boundary region 300, the small region 100 (candidate region 200) in which the brightness difference value from at least one or more small regions 100 is equal to or larger than a predetermined threshold value, from among the small regions 100 adjacent on the upper, lower, left, and right sides.

The extraction module 23 outputs information on the extracted boundary region 300 to the identification module 24.

The identification module 24 identifies a deposit region based on the boundary region 300 extracted by the extraction module 23. Specifically, the identification module 24 identifies the candidate region 200 as a deposit region when the number of boundary regions 300 satisfies a predetermined identification condition.

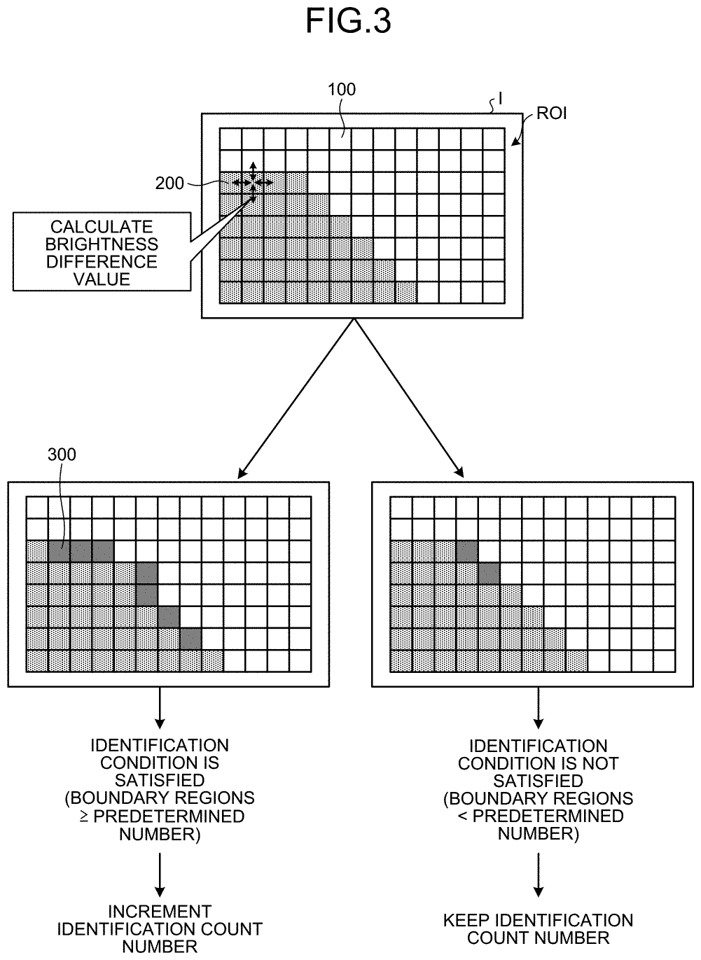

Referring now to FIG. 3, a process in the identification module 24 will be described. FIG. 3 is a diagram illustrating a process in the control unit 2 including the identification module 24.

As illustrated in the upper section of FIG. 3, the extraction module 23 calculates brightness difference values from adjacent small regions 100 with reference to a small region 100 included in the candidate region 200 and extracts a boundary region 300 based on the brightness difference values. That is, the small regions 100 adjacent to the small region 100 as a reference include small regions 100 (lower, left, right) included in the candidate region 200 and a small region 100 (upper) not included in the candidate region 200.

Here, the left and right diagrams in the lower section of FIG. 3 illustrate a case where there are many (equal to or larger than a predetermined number) boundary regions 300 extracted by the extraction module 23 and a case where there are few (less than the predetermined number).

As illustrated in the left diagram in the lower section of FIG. 3, when the number of boundary regions 300 is equal to or larger than the predetermined number, the identification module 24 determines that the identification condition is satisfied, and increments an identification count number indicating the number of times the identification condition is satisfied. The identification module 24 then identifies the candidate region 200 as a deposit region when the identification count number reaches a predetermined number or larger.

In this way, the identification module 24 can identify the candidate region 200 as a deposit region when a certain number or more of boundary regions 300 are continuously extracted, and therefore can reduce erroneous detection of a deposit region when the number of boundary regions 300 is temporarily equal to or larger than the predetermined number.

On the other hand, when the number of boundary regions 300 is smaller than the predetermined number, the identification module 24 determines that the identification condition is not satisfied, and keeps the identification count number. Then, when a non-identification count number indicating the number of times the identification condition is not satisfied continues by a predetermined number or more, the identification module 24 determines that the candidate region 200 is not a deposit region, that is, the candidate region 200 is a non-deposit region.

As described above, the identification module 24 determines that the identification condition is satisfied when the number of boundary regions 300 is equal to or larger than the predetermined number. That is, the identification module 24 determines that the identification condition is satisfied if a certain number or more of boundary regions 300 are extracted, irrespective of the size of the candidate region 200.

This process can simplify computation for an identification process for a deposit region and therefore can reduce the process load on the control unit 2. Variation in number of boundary regions 300 due to the sizes of the candidate regions 200 can be suppressed by extracting a boundary region 300 for each small region 100 that is a set of a certain number of pixels in the predetermined region ROI.

The identification module 24 may determine whether the identification condition is satisfied, for example, based on the ratio of the number of boundary regions 300 to the predetermined region ROI.

Then, when the candidate region 200 is identified as a non-deposit region as a result of the identification process by the identification module 24, the detection module 22 resets the candidate count number described above to a predetermined value. This point is described with reference to FIG. 4.

FIG. 4 is a diagram illustrating the process of resetting the candidate count number by the detection module 22. FIG. 4 illustrates the candidate region 200 identified as a non-deposit region by the identification module 24. In FIG. 4, the left diagram illustrates a case where the number of small regions 100 included in the candidate region 200 is equal to or larger than a predetermined number, and the right diagram illustrates a case where the number of small regions 100 included in the candidate region 200 is smaller than the predetermined number. In FIG. 4, it is assumed that the candidate count number serving as a criterion for determination of a candidate region 200 is five (or more).

As illustrated in the left diagram in FIG. 4, when the number of small regions 100 included in the candidate region 200 is equal to or larger than the predetermined number, the detection module 22 returns the candidate count number to a predetermined value if the identification module 24 determines that the number of boundary regions 300 does not satisfy the identification condition.

In the example illustrated in the left diagram in FIG. 4, the candidate count number “5” is reset to “3”. Since the reset candidate value falls below the candidate count number “5” by which a candidate region 200 is determined, a detection process is performed in a state of not being a candidate region 200, in the next process.

In this way, when the identification module 24 determines that the number of boundary regions 300 does not satisfy the identification condition, the candidate count number is returned to a predetermined value, whereby the determination of the candidate region 200 can be performed again by clearing the determination result of the candidate region 200. Accordingly, erroneous detection of a non-deposit region as a deposit region can be reduced.

On the other hand, as illustrated in the right diagram in FIG. 4, when the number of small regions 100 included in the candidate region 200 is smaller than the predetermined number, the detection module 22 prohibits the candidate count number from returning to the predetermined value if the identification module 24 determines that the number of boundary regions 300 does not satisfy the identification condition.

In the example illustrated in the right diagram in FIG. 4, the candidate count number “5” is kept. With this process, since an extraction process of extracting the candidate region 200 can be performed continuously in the next process, the deposit detection accuracy in a case where a relatively small amount of dirt adheres can be increased.

The detection module 22 may return the candidate count number to the predetermined value even when the number of small regions 100 included in the candidate region 200 is smaller than the predetermined number. That is, when the identification module 24 determines that the number of boundary regions 300 does not satisfy the identification condition, the detection module 22 may return the candidate count number to the predetermined value.

The candidate count number after reset by the detection module 22 may be any value equal to or larger than zero.

Returning to FIG. 2, the flag output module 25 is described. The flag output module 25 outputs a deposit flag ON to the various equipment 50 when the identification module 24 identifies a deposit region. On the other hand, the flag output module 25 outputs a deposit flag OFF to the various equipment 50 when the identification module 24 identifies a non-deposit region.

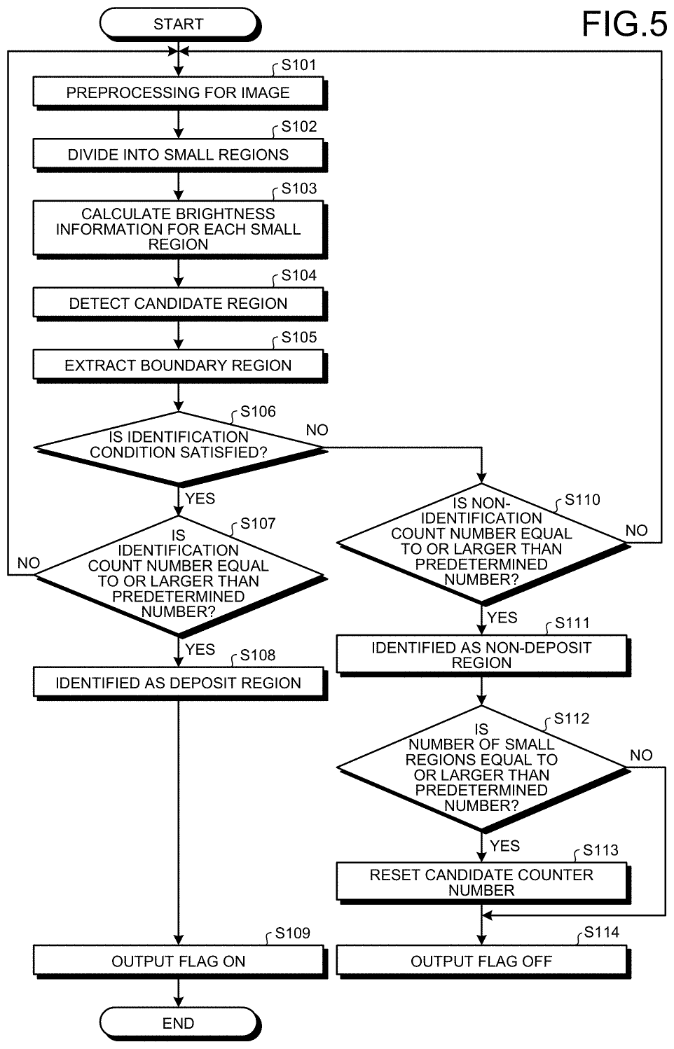

Referring now to FIG. 5, the procedure of the process performed by the deposit detection device 1 according to an embodiment will be described. FIG. 5 is a flowchart illustrating the procedure of the process performed by the deposit detection device 1 according to an embodiment.

As illustrated in FIG. 5, first of all, the preprocessing module 21 acquires an image captured by the camera 10 and performs preprocessing on the acquired captured image I (step S101). As used herein, the preprocessing is a process of performing the gray-scale process and the thinning process and thereafter generating an integrated image based on pixel values of the reduced image.

Subsequently, the detection module 22 divides a predetermined region ROI in the captured image I into small regions 100 (step S102).

Subsequently, the detection module 22 calculates brightness information indicating a feature amount of brightness for each small region (step S103). The feature amount of brightness is, for example, an average value of brightness and a standard deviation of brightness.

Subsequently, the detection module 22 detects a candidate region 200 for a deposit region, based on the calculated brightness information (step S104).

Subsequently, the extraction module 23 extracts, as a boundary region 300, the small region 100 in which the brightness difference value from the small region 100 adjacent to the small region 100 is equal to or larger than a predetermined threshold value, from among the small regions 100 included in the candidate region 200 detected by the detection module 22 (step S105).

Subsequently, the identification module 24 determines whether the number of boundary regions 300 extracted by the extraction module 23 satisfies a predetermined identification condition (step S106).

If the number of boundary regions 300 satisfies the predetermined identification condition (Yes at step S106), the identification module 24 increments the identification count number and determines whether the identification count number is equal to or larger than a predetermined number (step S107).

If the identification count number is equal to or larger than the predetermined number (Yes at step S107), the identification module 24 identifies the candidate region 200 as a deposit region (step S108).

Subsequently, if the identification module 24 identifies the candidate region 200 as a deposit region, the flag output module 25 outputs the deposit flag ON to the various equipment 50 (step S109) and terminates the process.

On the other hand, if the number of boundary regions 300 does not satisfy the identification condition at step S106 (No at step S106), the identification module 24 increments the non-identification count number and determines whether the non-identification count number is equal to or larger than a predetermined number (step S110).

If the non-identification count number is equal to or larger than the predetermined number (Yes at step S110), the identification module 24 identifies the candidate region 200 as a non-deposit region (step S111).

Subsequently, the detection module 22 determines whether the number of small regions 100 included in the candidate region 200 is equal to or larger than a predetermined number (step S112).

If the number of small regions 100 is equal to or larger than the predetermined number (Yes at step S112), the detection module 22 resets the candidate counter number to a predetermined value (step S113).

If the identification module 24 identifies the candidate region 200 as a non-deposit region, the flag output module 25 outputs the deposit flag OFF to the various equipment 50 (step S114) and terminates the process.

On the other hand, if the identification count number is smaller than the predetermined number at step S107 (No at step S107), the identification module 24 proceeds to the process at step S101.

If the non-identification count number is smaller than the predetermined number at step S110 (No at step S110), the identification module 24 proceeds to the process at step S101.

If the number of small regions 100 included in the candidate region 200 is smaller than the predetermined number at step S112 (No at step S112), the detection module 22 proceeds to the process at step S114.

As described above, the deposit detection device 1 according to the embodiment includes the detection module 22, the extraction module 23, and the identification module 24. The detection module 22 detects a candidate region 200 for a deposit region corresponding to a deposit adhering to an imaging device, based on brightness information for each of small regions 100 into which a predetermined region ROI in an image (captured image I) captured by the imaging device (camera 10) is divided. The extraction module 23 extracts, as a boundary region 300, the small region 100 in which a brightness difference value from the small region 100 adjacent to the small region 100 is equal to or larger than a predetermined threshold value, from among the small regions 100 included in the candidate region 200 detected by the detection module 22. The identification module 24 identifies the candidate region 200 as a deposit region when the number of boundary regions 300 extracted by the extraction module 23 satisfies a predetermined identification condition. With this configuration, a deposit can be detected with high accuracy.

In the foregoing embodiment, the captured image I captured by a camera mounted on a vehicle is used. However, the captured image I may be, for example, a captured image I captured by a security camera or a camera installed on a street lamp. That is, the captured image I may be any captured image captured by a camera with a lens to which a deposit may adhere.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A deposit detection device comprising:
a detection module configured to detect a candidate region for a deposit region corresponding to a deposit adhering to an imaging device, based on brightness information for each of small regions into which a predetermined region in an image captured by the imaging device is divided;
an extraction module configured to extract, as a boundary region, the small region in which a brightness difference value from the small region adjacent to the small region is equal to or larger than a predetermined threshold value, from among the small regions included in the candidate region detected by the detection module; and
an identification module configured to identify the candidate region as the deposit region when the number of the boundary regions extracted by the extraction module satisfies a predetermined identification condition.

2. The deposit detection device according to claim 1, wherein the identification module identifies the candidate region as the deposit region when an identification count number indicating the number of times the number of the boundary regions satisfies the identification condition reaches a predetermined number or larger.

3. The deposit detection device according to claim 1, wherein when the number of the boundary regions is equal to or larger than a predetermined number, the identification module determines that the identification condition is satisfied and identifies the candidate region as the deposit region.

4. The deposit detection device according to claim 1, wherein when the number of the small regions in which a candidate count number indicating the number of times the brightness information satisfies a predetermined candidate condition reaches a predetermined number or larger is equal to or larger than a predetermined number, the detection module detects the predetermined number of the small regions as the candidate region, and the detection module returns the candidate count number to a predetermined value when the identification module determines that the number of the boundary regions does not satisfy the identification condition.

5. The deposit detection device according to claim 4, wherein when the number of the small regions included in the candidate region is smaller than a predetermined number, the detection module prohibits the candidate count number from returning to a predetermined value when the identification module determines that the number of the boundary regions does not satisfy the identification condition.

6. A deposit detection method comprising:
detecting a candidate region for a deposit region corresponding to a deposit adhering to an imaging device, based on brightness information for each of small regions into which a predetermined region in an image captured by the imaging device is divided;
extracting, as a boundary region, the small region in which a brightness difference value from the small region adjacent to the small region is equal to or larger than a predetermined threshold value, from among the small regions included in the candidate region detected at the detecting; and
identifying the candidate region as the deposit region when the number of the boundary regions extracted at the extracting satisfies a predetermined identification condition.
